(19) United States
(12) Patent Application Publication
(10) Pub. No.: US 2013/0236864 A1
(43) Pub. Date: Sep. 12, 2013

(54) Use of colored beads in an augmented simple abacus

(71) Applicant: James Richard Harte, Kansas City, MO (US)

(72) Inventor: James Richard Harte, Kansas City, MO (US)

(21) Appl. No.: 13/385,812

(22) Filed: Mar. 8, 2012

(51) Int. Cl. G09B 19/02

(52) U.S. Cl. 434/203

(57) ABSTRACT

The use of colored beads with an augmented simple abacus, adds an addition or expansion to the previous augmentations described in my previous patent which has the title: Augmented Simple Abacus With an Underlying Grid of Numbers or a Blank Sheet. And this invention has been given Publication No. US-2012-0028229-A1, and a Publication Date of: Feb. 1, 2012.

This addition of colored beads to an augmented simple abacus is very helpful to the user in understanding or gaining insight into the relationships of numbers under 100. And the use of colored beads is very helpful to users of these types of abacuses in learning to: count, add, subtract, and learn the multiplication tables. And colored beads are also helpful in gaining an understanding of the “factors” in many numbers, and also in understanding the common factors in many numbers.

### CROSS REFERENCES TO RELATED U.S. PATENTS

The major cross reference is with my current pending U.S. Patent Application: Augmented Simple Abacus With an Underlying Grid of Numbers, or a Blank Sheet; this was given application Ser. No. 12/804,825; Filing Date Jul. 30, 2010.

Patents with some relevance to this current patent application include:

| | U.S. Patents | Granted | Filing Date | |
|---|---|---|---|---|
| Numbers | Granted to: | on: | on | Class/Subclass |
| 1,329,850 | E. Pye | Feb. 3, 1920 | Sep. 1, 1917 | |
| 1,532,011 | R. M. Williamson | Mar. 31, 1925 | Mar. 21, 1924 | 434/203 |
| 2,411,614 | C. C, Cohen | Nov. 26, 1946 | Mar. 3, 1945 | 434/203; 434/304 |
| 2,457,332 | F. A. Wade et al | Dec. 28, 1948 | Feb. 5, 1047 | 434/203 |
| 3,688,418 | H. W. Wilson | Sep. 5, 1972 | Mar. 9, 1970 | 434/403 |
| 4,488,159 | Fujiwara ET AL | Dec. 11, 1984 | Apr. 29, 1983 | 434/208 |
| 4,560,354 | S. T. Fowler | Dec. 24, 1985 | Oct. 11, 1984 | 434/208; 434/207 |
| 5/395,245 | T. Heinz | Mar. 7, 1995 | Nov. 4, 1993 | 434/207; 434/203 |
| 6,712,614 | G. P. Henderson | Mar. 30, 2004 | Feb. 7, 2001 | 434/203; 434/202 |

International Patents:

| | | | |
|---|---|---|---|
| JP 551500024 A | Y. I. Chikfusa | G06C1/00; (1PC 1-7) | G06C1/00 |

| | | | |
|---|---|---|---|
| CN 2435772 (Y) | Chao Zengli | G06C1/00; (196-17) | Granted on: May 22, 2008 |

Other information on the use of colored beads in abacuses, was found by reading or scanning books about the background history and use of abacuses with young children in Europe and the U.S.A. And I found five such books in the Library of the University of Missouri at Kansas City; and three such books in Linda Hall Library in Kansas City. The best or most informative book was: Tools of American Mathematics; 1800 to 2000; from John Hopkins History of Mathematics; Editor, Ronald Clinger, Published 2008; that has one chapter, Chapter 7, on the history of the use of abacuses in American Schools. In chapter 7, it notes that a man in London, England, Samuel Witherspoon, in 1825 introduced the use of two different colors of beads (black & white) in an abacus.

And in Chapter 7, it also notes that a man by the name of Wilson, in England in 1830, constructed and used of an abacus with 12 rows of beads; with 12 beads on each row. And Wilson constructed these abacuses with 12 different colors of wooden beads; with one different color of beads for each row of 12 rows of beads.

### NO FEDERAL FUNDS WERE USED IN THE RESEARCH OR IN THE DEVELOPMENT OF THIS PATENT APPLICATION

### NO SEQUENCE LISTING, HARD OR SOFT COMPUTER DISK, OR COMPUTER PROGRAM WAS USED WITH THIS PATENT APPLICATION, OTHER THAN: 1.) THE USE OF A WORD PROCESSOR; 2.) THE USE OF A SEARCH ENGINE SUCH AS GOOGLE; AND 3.) THE SEARCH PROCESSES AVAILABLE VIA THE U.S. PATENT OFFICE

### BACKGROUND OF INVENTION

Abacuses were used by the Greeks and others in Asia Minor, and the Near East before the birth of Christ. And it is suspected that abacuses were derived from “counting boards”, which had a number of parallel lines. And the spaces between these parallel lines indicated the value of each stone or bronze disk that was temporarily placed between a particular set of two parallel lines. The oldest “counting board” that has been found, was found on the Island of Salamis; which is a short distance from Athens, Greece. This “counting board” was made from a flat rectangular slab of white marble, which had 11 parallel straight lines engraved in its upper surface. Similar counting boards were used in Europe until the 16^{th} century. Reference: The Abacus; Its History; Its Design; Its Possibilities in the Modern World; by Parry Moon, of the Massachusetts Institute of Technology, published in 1971, by Gordon and Bach Scientific Publications, New York. This book, and several other books on the history of the abacus, describe the evolution of abacuses over time, and place; to where there are now a number of major types of abacuses which have some different features, and some operate in a slightly different way.

These major types of abacuses include: what are now called a Chinese Abacus; The Roman Abacus; The Japanese Abacus (or Soroban), The Russian Abacus, and a variation of the Russian Abacus which I call a Simple Abacus. Several of these books on the history of the abacus describe how two or more French soldiers of Napoleon encountered the Russian Abacus in Russia. And after their return to France two of these French soldiers used this Russian abacus with ten beads per row of beads in a different way than this Russian Abacus was primarily used in Russia. In Russia, each of the rows of ten beads, from top to bottom, was increased by a value of ten per bead in the top row to bottom row.

The two soldiers who returned to France from Russia about 1813, or 1814, were former teachers who returned to teaching young children. And they changed the use of the Russian abacus, to where each bead was given a value of one per bead, regardless of its location; as long as this bead, and all previous beads were pushed against the left side “counter bar”. With this change in pattern of use, the top row of ten beads were used to teach children to count the number sequence from 1 to 10; when each of these beads was progressively pressed against the left side “counter bar”. And when the beads in the top row had all been pushed or pressed against the counter bar; then the student user could go to the second row of ten beads, and starting on the left hand side, press each bead, one at a time, against the left hand side counter bar. And by this method, the student user could learn the number sequence of 11 to 20 by pushing one bead at a time against the left hand side counter bar, in the second row of beads.

And before 1820 these ideas and simple abacuses were introduced into England, where printed materials and booklets explained and illustrated these ideas. And some of these booklets were sent to the USA. And some teachers in France who had used these simple abacuses in France, migrated to the USA in the early 1800's. And by 1830 these simple abacuses were in use in a few schools in the USA.

I was sent to Seoul, Korea in September 1946 by the U.S. Army. And when I made purchases in Seoul Korea, the merchants all used an abacus to add up the cost of the items I had purchased. And before I returned to the USA, I purchased two slightly different types of abacuses in Seoul. And on my return to the USA, I showed and demonstrated these two types of abacuses to my family and friends.

And between 1957 and 2003, I spent about 80% of my work time in the area of Child and Adolescent Psychiatry. And I evaluated and worked with literally hundreds of children and adolescents during this time span. And though these children and adolescents were seen by me for a wide range of problems of: thought, mood, behavior, attention span, impulse control; and emotional control, I found that about 50% had major problems learning to read English words, in spite of good general intelligence. And a much smaller percent of these children and adolescents had problems with arithmetic skills and knowledge.

And initially I focused my time and attention on the major problem of the poor ability to read English words by such a large number of children and adolescents. But after I sent of a patent application that I called: Progressive Synthetic Phonics, to the U.S. Patent office, decided to take a look at why some children and adolescents had a significant problem with acquiring math knowledge and skills in spite of reasonably good general intelligence. And as I had built between 25 and 40 abacuses of several types between 1965 and 2003, to give to my patients who had a problem with math knowledge and math skills, for their use for practice and drill; I had some knowledge of the various types of abacuses, and how they were used.

And I decided to use the two libraries noted previously to read or scan the books they had on abacuses to see if I could get any clues as to how the use of abacuses might be improved. And I read one book on abacuses, published in 2000 AD that said that abacuses were rarely used anymore in elementary schools to help young children learn math skills and knowledge. And as I thought about this current rare use of abacuses in elementary schools, I thought something must be missing. And I decided that I should study simple abacuses with the idea in mind that one or more things needed to be added to improve their value or to improve their helpfulness to young children to learn math skills and knowledge. And this led directly to my ideas that are explained in my U.S. Patent application: Augmented Simple Abacuses, which has application Ser. No. 12/804,825, filing date: Jul. 30, 2010.

But as I was building abacuses that conformed with the ideas or concepts outlined in the above U.S. Patent application, it soon became evident to me that beads of different colors could also be used to help young children master the basic math concepts of: the multiplication tables, and multiplication and division, and learning about the “factors” of various numbers below 100. Here I am using the term “factors” the way it is used in the language of mathematics, where a “factor” is a number or symbol that is multiplied by a second (or third) “factor” (number or symbol) to produce a “product”. An illustration of this is: 3×4=12. And in this simple equation the numbers 3 and 4 are “factors”, that when multiplied together, produce the “product” of: 12. However the number 12 also has two other factors, the numbers 6 and 2. And when the numbers 6 and 2 are multiplied together this gives you the product of 12, as: 2×6=12. And many other numbers under 100 can also be the product of more than one set of multiplier and multiplicand. If one looks at the number 96, its possible factors are: 2, 3, 4, 6, 8, 12, 16, 24, 32, and 48.

And in reading about the types and uses of abacuses of various types, I was unable to locate any information where different colored beads had previously been used to illustrate the different “factors” in numbers of 100 or less.

And different colored beads can also be used to illustrate different numbers or factors that are 10 or under, and colored beads can also be used as a part of learning the multiplication tables.

### BRIEF SUMMARY OF THE INVENTION

This invention: The Use of Different Colored Beads With an Augmented Simple Abacus; is an extension of an earlier invention given under application Ser. No. 12/804, 825. This earlier application does not include the use of colored beads with an augmented simple abacus. With an Augmented Simple Abacus, the beginning learner of math skills and knowledge, can see the number of each bead, above that bead, where these numbers have been placed in a grid of numbers, that are placed beneath the beads on a bottom flat surface; and these beads may be pushed into direct or indirect contact with the “counter bar”, and then the correct number of a given bead appears above each bead.

The use of beads of different colors with an augmented simple abacus has a number of uses in helping beginning learners of arithmetic in mastering the skills and knowledge of: learning: to count, addition; subtraction; the multiplication tables; and in learning the “factors” of numbers of under 100 by the manipulation of these beads. By using beads of different colors to indicate the numerical relationships of these beads, this adds a new dimension to the information feedback that the user of this augmented simple abacus gets

And after filing for a U.S. Patent on this concept of adding three additional parts to a simple abacus; which include: 1.) adding a flat bottom surface such as a small piece of plywood to the bottom of the wooden frame of the simple abacus: 2.) placing a printed grid of numbers on this flat bottom surface; and 3.) locating numbers on this printed grid so that when the beads on the dowels, rods, or rope segments, were all pushed over to touch the “counter bar”, and pressed against the counter bar; then above each bead would appear the number of that bead in a numerical sequence of 1 to 30, or 1 to 50, or 1 to 100: depending on the number of dowels or rods, used in that simple abacus.

And while building a number of types of this augmented simple abacus I became aware to the additional value for young children of the use of colored beads on the dowels or rods of this augmented simple abacus; as it was easier to see the relationships between beads of the same colors, where these beads represented the same “factor”. (Here I am using the word “factor” as it is used in math language; where a factor is one of two or more numbers or symbols that are multiplied together to produce a product as in: 2×3=6.)

### BRIEF DESCRIPTION OF SEVERAL VIEWS OF THE DRAWINGS

(Please Use Drawing # 4 to print in the abstract when, or if this patent application is granted.)

FIGS. 1, 2, 3, and 4, are similar. And FIGS. 1, 2, 3, and 4, are variations or sub-types of the same general concepts or set of ideas, of how to use colored beads to represent different numbers, or to represent a number that is a “factor” in some of the larger numbers shown in an augmented simple abacus. And here the word “factor” is used in a way that is found in math language, where a “factor” or “factors” are numbers or symbols that are used in an equation; where the “factors” are two or more parts, that when multiplied together produce a product; such as 3 and 4 are the two factors in : 3×4=12.

FIG. 1 of the four drawings, is the top view of one of the “sub-types” of “The Use Colored Beads in an Augmented Simple Abacus”. In FIG. 1, and also in FIGS. 2, 3, and 4; the numbers: 1, 2, 3, 4, 5, 6, and 7 each describe a part or element of an augmented simple abacus that is common to each of four sub-types of this invention, as shown in: Drawings: 1, 2, 3, and 4. (So far I have made ten different sub-types.)

This invention, “The Use of Colored Beads in an Augmented Simple Abacus”, is an extension of my previous invention: “Augmented Simple Abacus With an Underlying Grid of Numbers, or a Blank Sheet”. A patent application for this previous invention has: Publication No. US-2012-0028229-A1; and Publication Date: Feb. 2, 2012.

The augmented simple abacus, as described and illustrated in Publication No. US-2012-0028229-A1 does not show, illustrate, or describe the use of colored beads.

Number 1, in Drawings: 1, 2, 3, and 4, is the flat plywood bottom for an augmented simple abacus, as is described in Publication No. US-2012-0028229-A1.

Number 2 in Drawings: 1, 2, 3, and 4. is the “counter bar” in the augmented simple abacus as is described in Publication No. US-2012-0028229-A1.

Number 3 in Drawings: 1, 2, 3, and 4, is the “non-counter bar” in the augmented simple abacus, as is described in Publication No. US-2012-0028229-A1

Number 4 in Drawings: 1, 2, 3, and 4, is a printed sheet with a grid of numbers, as is described in Publication No, US-2012-0028229-A1.

Number 5 in Drawings: 1, 2, 3, and 4 represent the wooden dowels or rods (or wires or rope segments) which carry the beads; and which are located as horizontal parallel rows above the flat bottom surface. And the dowels are held in place in sets of holes in the left and right edge pieces. And these left and right edge pieces are also used as: the counter bar (left side); and the non-counter bar (right side). And this is described in Publication No. US-2012-0028229-A1.

Number 6 in Drawings: 1, 2, 3, and 4, represents the numbers on the printed grid of numbers as is described in Publication No. UA-2012-0028229-A1.

Number 7 in Drawings: 1, 2, 3, and 4, represent white beads, or beads that are not the focus of attention. And in this patent application, white beads may also represent the “prime numbers” of under 100 that have no “factors” than that number, and number one. Thus such “prime numbers” as: 1, 3, 5, 7, 11, 13, 17, 19, 23, and 29, are numbers that cannot be divided by a smaller number without leaving a fraction. And these “prime numbers” may be shown as white beads, or by beads of another single color.

For numbers under 100 that cannot be produced by multiplying together two numbers under 100; any color may be chosen to represent these types of “prime numbers”.

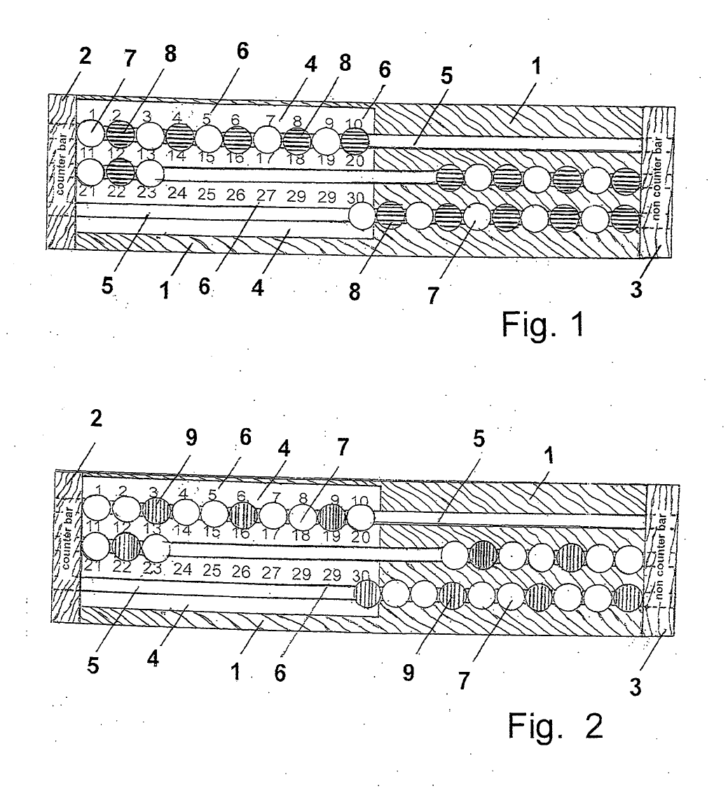

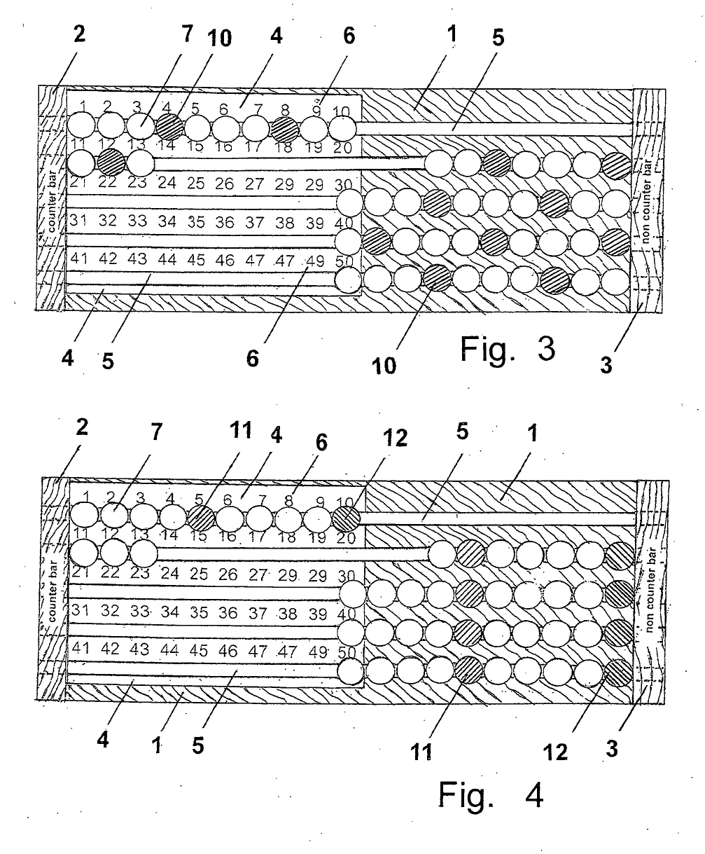

Number 8, that appears in FIG. 1, represent beads that will appear under the “even” numbers, or numbers that end in: 2, 4, 6, 8, or 0; when this bead, and all previous beads have been pushed against the “counter bar”. And the beads that represent the even numbers in FIG. 1, are all of the same color (such as red) to show their numerical relationship to one another. And this is to help beginners in learning arithmetic to become aware of “odd numbers”, and “even numbers”; and also to help beginners to learn the multiplication tables of two times other numbers under ten.

Number 9, that appears in FIG. 2, represent the beads that will appear below numbers that can be divided “evenly” by number 3, when all previous beads have been pushed against the “counter bar”. And these beads that may appear below numbers that can be evenly divided by the number three, are illustrated by having vertical lines drawn through these beads. And when sub-types of augmented simple abacuses have more than three horizontal dowels or rods, the numbers of less that 100 that can be evenly divided by the number three may be represented by the same color of bead that is used to show that the number 3 is a “common factor” with the “3 times” multiplication tables.

The number 10 in FIG. 3 is used to represent the beads with numbers of under 100 that can be evenly divided by the number 4, when that bead, and all previous beads have been pushed against the “counter bar”. And these beads that can represent the “factor” of 4 are all of the same color. And this set of colored beads can help beginning math students learn the multiplication tables of 4 times other numbers that are 10 or under.

And in FIG. 4, there are two different colors of beads to represent the numbers 5 and 10, when all previous beads have been pushed against the counter bar. And these beads that represent the numbers 5 and 10 are shaded with diagonal lines. But beads that potentially represent numbers ending in the number 5, have a series of lines with the top of the line on the right, and the bottom of the line on the left.

And in FIG. 4, the beads that potentially represent the numbers below 100 where the number 10 can be one of the factors; have a pattern of diagonal lines where the top of the line is on the left and the bottom of the line is on the right.

And the manner of representing different numbers of twelve or under by having beads of different colors represent different numbers can be carried out with the numbers: 6, 7, 8, 9, 10, 11, and 12; in a manner similar to that demonstrated in FIGS. 1, 2, 3, and 4.

### DETAILED DESCRIPTION OF THE INVENTION

This invention is an expansion of my previous invention that has a title of: “Augmented Simple Abacus With an Underlying Grid of Numbers or a Blank Sheet”; which has been given Publication No. US-2012-0028229-A1; Publication Date: 02/02/2012

In the initial invention, (noted in the above paragraph) the focus of the invention was on the addition or augmentation by three components: 1.) The addition of a hard flat bottom that is permanently (or temporarily) attached to the under side of the frame of an augmented simple abacus as a small sheet of plywood); 2.) the placement of a printed grid of numbers on this bottom surface, where this grid of numbers is organized and located on this bottom surface, so that all beads that have become “counters”, by being pushed into the counter area and are pressed against the counter bar (on the left hand side of the abacus), will have the correct number of each bead appear above each bead that has become a counter; and 3.) that different printed sheets, will have different patterns of printed numbers that may be placed on this bottom surface to help students of math learn: addition, subtraction, and the individual multiplication tables of the numbers one through ten.

And in building a number of these Augmented Simple Abacuses, after I had filed for a patent on this invention or innovation, I became aware that by having certain colors of beads assigned to the different numbers (or factors) of certain of the multiplication tables, and certain larger numbers, it was easier for young children to learn the multiplication tables.

And an example of the above is, that I built a number of Augmented Simple Abacuses where all odd numbers were above white plastic beads; and where all even numbers were above red plastic beads (when these plastic beads were pushed against the counter bar.) And these colored beads also helped beginners learn the multiplication tables with the number two being one of the “factors”. (In math language “factors” are the numbers or symbols that are multiplied together to produce a product as in: 2×3=6.)

And in a way similar to the way noted above; I built a number of augmented Simple abacuses, where the numbers: 3, 6, 9, 12, 15, 18, 21, 24, 27, and 30 were all above yellow beads, when all previous beads had been pushed against the counter bar; and all other numbers from one to thirty were above white beads. And this helped young children learn the multiplication tables where the number three was the main “factor”.

And in a way similar to the way noted above; I built a number of augmented simple abacuses, where the numbers: 4, 8, 12, 16, 20, 24, 28, 32, 36, 40, 44, and 48 were all above orange beads; and where other colored beads were above all other numbers between #1 and #50. And the goal of these augmented simple abacuses was to present all of the numbers under 50 that were multiples of the number 4. And again the idea was to have children learn the set of multiplication tables and other numbers where 4 was one of the primary “factors” in the larger numbers.

And in a way similar to the ways noted above, I built a number of augmented simple abacuses that contained 50 beads, in five rows of beads. And where below all numbers that ended in 5 or 10 (5, 10, 15, 20, 25, 30, 35, 40, 45, and 50) were blue beads; when all 50 beads were pushed against the counter bar. (And beads that ended up under a number ending in 5 (5, 15, 25, 35, 45) were light blue; and all beads that ended up under a 0 (10, 20. 30, 40, 50) were dark blue in color—when all 50 beads were pushed against the counter bar.

And in a manner similar to paragraph #[0043] above. I built a number of augmented simple abacuses that contained 100 beads; with light blue beads ending up under numbers ending in 5, and dark blue beads ending up under numbers ending in 0—when all beads were pressed against the counter bar.

And I built several similar augmented simple abacuses with multiples of 6 being green in color; and multiples of 7 being black in color.

And during the Thanksgiving 2011 Holiday period, I gave to my grand daughter and her husband one of the augmented simple abacuses that contained 10 light blue beads and 10 dark blue beads along with 80 white beads. And during the Christmas 2011 Holiday period, their 6 year old son told me: “I know my 5's and 10's multiplication tables”. And he then spoke the correct sequence of: 5, 10, 15, 20, 25, 30—and so on until he had reached 100.

What I claim as new in this invention are:

1. The use of beads of 10 or more different colors in an augmented simple abacus where the color of a bead will indicate to the user of a bead: 1.) it's number by it's different color; or 2.) where the color of a bead will indicate to the user that this bead is a certain number “factor” in a larger number; when these different colored beads are placed in a sequence on the rods or rope segments of an augmented simple abacus; and when all previous beads on all previous rows have been pressed against the counter bar; or are being pressed against beads that have been previously pushed against the counter bar. And then printed on a flat surface below that bead will appear above that bead on this printed flat surface a number, to indicate to the user the number of that bead in that sequence of beads.

2. The use of beads of different colors as in claim 1, but where the color of a bead not only indicates: 1.) the number of that bead for a number below number 12; but 2.) in numbers above 10; the color of a bead may also indicate one factor (number) of this larger number that is represented by this color (such as in the multiplication tables). As an example, in FIG. 4, where all numbers having a blue color are a multiple of 5,—as in: 5, 10, 15, 20, 25, 30, 35, etc.; and these numbers that are multiples of 5, will appear above a blue colored bead, on a printed flat surface or sheet that is positioned below the rods or rope segments that contain the beads when all of the beads in the counter area, when the lower numbers have been pressed against the counter bar; or have been pressed against previous beads of lower number that have been pressed against the counter bar. (And I believe that claim 2 is a sub-claim, illustration, or a more concrete restatement of claim 1, above.)

3. The use of an augmented simple abacus with beads of the same general color but with different shades of the same color, when there is a numerical relationship (such as a common factor) between two or more of these different numbers, when these beads may have different shades of the same color:
one example of this is: having all beads that represent the number 2 being pink; and having all beads that represent the number 4 being a medium shade of red; and having all beads that represent the number 8 being a darker shade of red; and having larger numbers that contain any of these factors of: 2, 4, and 8, in such numbers as 16, 24, and 32 being represented by any of the three shades of red, which represent the factors: 2, 4, or 8.
and a second example of this is having the number 5 being a light blue in color and the number 10 being a dark blue in color; (And this is illustrated in FIG. 4, in the drawings.); and having numbers ending in a 5, such as: 5, 15, 25, 35, 45, & 55, being light blue in color; and having numbers ending in 0, such as: 10, 20, 30, & 40, being dark blue in color; when all previous beads on all rods or rope segments have been pushed against the counter bar; then the printed numbers on a flat surface or paper, below these rods or rope segments will appear above that the bead indicated by that printed number.

4. (A “prime number” is a number that has no factors other than it's own number, and the number one.) The use of beads of the same color to represent numbers under 100 that are prime numbers; (and the color used to indicate “prime numbers” is not being used by another set of beads); where this color of bead will or may appear above all or many of the “prime numbers”; when previous beads of lower number have all been pressed against the counter bar, or have been pressed against one or more beads that are pressed against the counter bar.
